(19) United States
(12) Patent Application Publication
(10) Pub. No.: US 2016/0020970 A1
(43) Pub. Date: Jan. 21, 2016

(54) ROUTER AND INFORMATION-COLLECTION METHOD THEREOF

(71) Applicant: WISTRON NEWEB CORP., Hsinchu (TW)

(72) Inventor: YI-TING TING, HSINCHU (TW)

(21) Appl. No.: 14/795,550

(22) Filed: Jul. 9, 2015

(30) Foreign Application Priority Data
Jul. 15, 2014 (TW) 103124208

(51) Int. Cl. H04L 12/26; H04L 29/08

(52) U.S. Cl. CPC H04L 43/062; H04L 67/02

(57) ABSTRACT

The present invention provides a router including a storage device, a communication module, and a controller. The storage device stores a web-page code corresponding to a graphical user interface, wherein the web-page code includes an information-gathering code. The controller enables the communication module to transmit the web-page code to the first electronic device coupled in response to a predetermined web-page request received from the first electronic device, wherein the information-gathering code is arranged to collect an environment information sector of the first electronic device and transmit the environment information sector of the first electronic device to the router.

### CROSS REFERENCE TO RELATED APPLICATIONS

This Application claims priority of Taiwan Patent Application No. 103124208, filed on Jul. 15, 2014, the entirety of which is incorporated by reference herein.

### BACKGROUND OF THE INVENTION

1. Field of the Invention

The present invention relates to a router, and in particular to a router capable of collecting user information.

2. Description of the Related Art

Presently, mobile devices are highly developed and multi-functional. For example, handheld devices such as mobile phones and tablets are capable of conducting telecommunications, receiving and transmitting e-mails, maintaining social networks, managing contacts, and playing media. Hence, users can implement various applications on their mobile devices, such as a simple phone call, social network interaction, or commercial transaction.

Most current handheld devices include a communication module arranged to perform a wireless or wired communication. Therefore, usage of routers is becoming more frequent. However, router settings are complicated, and it may cause inconvenience to users.

### BRIEF SUMMARY OF THE INVENTION

A detailed description is given in the following embodiments with reference to the accompanying drawings.

The present invention provides a router. The router includes a storage device, a communication module, and a controller. The storage device is arranged to store a web-page code corresponding to a graphical user interface, wherein the web-page code includes an information-gathering code. The communication module is coupled to a plurality of electronic devices. The controller is arranged to enable the communication module to transmit the web-page code to the first electronic device of the plurality of electronic devices in response to a predetermined web-page request received by the communication module from the first electronic device, wherein the information-gathering code is arranged to collect an environment information sector of the first electronic device and transmit the environment information sector of the first electronic device to the router.

The present invention further provides an information collection method. The information collection method is applied to a plurality of electronic devices coupled with a router. The information collection method includes: determining whether a predetermined web-page request has been received from the coupled electronic devices; and transmitting a web-page code to the first electronic device when the predetermined web-page request is received from the first electronic device, wherein the web-page code includes an information-gathering code, and the information-gathering code is arranged to collect an environment information sector of the first electronic device.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of router of the present disclosure;

FIG. 2 is a schematic diagram illustrating another embodiment of router of the present disclosure;

FIG. 3 is a flowchart of an information collection method according to an embodiment of the present disclosure;

FIG. 4 is a flowchart of an information collection method according to another embodiment of the present disclosure; and

FIG. 5 is a flowchart of an information collection method according to another embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

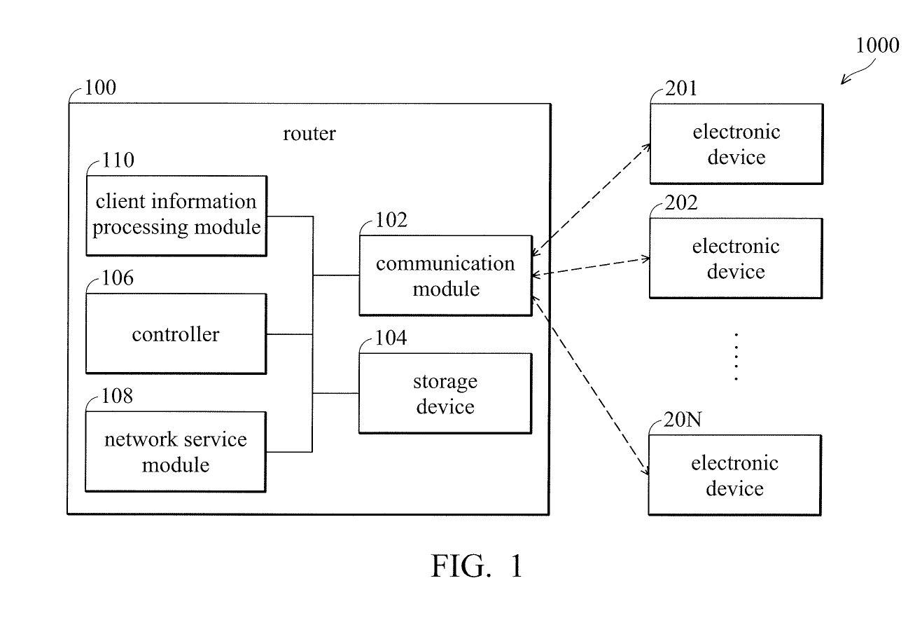

FIG. 1 is a schematic diagram illustrating an embodiment of an router of the present disclosure. The routing system 1000 includes a router 100 and a plurality of electronic devices 201˜20N. The router 100 is arranged to be coupled to the electronic devices 201˜20N, wherein the electronic devices 201˜20N are wired or wireless network devices. The router 100 is arranged to provide a routing mechanism for the electronic devices 201˜20N, wherein the routing mechanism is arranged to determine the routing path of network packets. Moreover, the router 100 is arranged to provide a transfer mechanism for the electronic devices 201˜20N, wherein the transfer mechanism is arranged to transmit the network packet of the input terminal of the router to the output terminal of the router. As shown in FIG. 1, the router 100 includes a communication module 102, a storage device 104, a controller 106, a network service module 108 and a client information processing module 110.

The communication module 102 is arranged to be coupled to the electronic devices 201˜20N by wire or wireless connection, wherein the electronic devices 201˜20N are coupled with each other by Local Area Network (LAN), but it is not limited thereto. Moreover, the communication module 102 is arranged to connect to the Internet by Wide Area Network (WAN) and assign Internet resources to the electronic devices 201˜20N.

The storage device 104 may include a read only memory (ROM), a flash ROM and/or random access memory (RAM) arranged to store the program arranged to be performed by the controller 106, the network service module 108 and the client information processing module 110. In one embodiment, the storage device 104 is arranged to store a web-page code and a setting table corresponding to a graphical user interface, wherein the web-page code includes an information-gathering code, but it is not limited thereto. In another embodiment, the web-page code and the information-gathering code are stored in the storage device 104, respectively, wherein the information-gathering code is written into the web-page code when the web-page code is going to be transmitted to the electronic devices 201˜20N. It should be noted that the setting table is arranged to store the environment information sectors of the electronic devices 201˜20N, respectively. It should be noted that the information-gathering code is arranged to collect the environment information sectors of the electronic devices 201˜20N, and transmit the collected environment information sectors to the router 100, wherein each one of the environment information sectors corresponds to a different electronic device. In one embodiment, the web-page code is Hyper Text Markup Language (HTML) and the information-gathering code is a script of Hyper Text Markup Language, but it is not limited thereto. The web-page code may be program code compatible to other languages.

The controller 106 includes a central-processing unit (CPU) or a plurality of processing units in a parallel processing environment. In one embodiment, the controller 106 is arranged to enable the communication module 102 to transmit the web-page code, which includes the information-gathering code, to the electronic device according to a predetermined web-page request received by the communication module 102 from the electronic device. For example, when the communication module 102 receives a predetermined web-page request from the first electronic device 201, the controller 106 enables the communication module 102 to transmit the web-page code, which includes the information-gathering code, to the first electronic device 201. In one embodiment, the browsers of the electronic devices 201˜20N are arranged to open a web page in response to the received web-page code and execute the information-gathering code of the web-page code in the background. In the period during which the web page is opened, the information-gathering code collects the environment information sector of the electronic device and enable the electronic device to transmit the collected environment information sector back to the router 100, wherein the environment information sector may include the network speed (speed test), the specifications of the network interface, the routing rule, the communication protocol, the browser type, the platform information, the operating system type and/or the computing capacity of the corresponding electronic device, but it is not limited thereto. In one embodiment, the environment information sector includes information about whether or not the corresponding electronic device supports the IPv6 communication protocol.

Next, after the router 100 has received the environment information transmitted by the information-gathering code, the router 100 calculates the received environment information sector by a specific algorithm and provides service according to the result of the calculation. The specific algorithm can be designed by the router development companies, but it is not limited thereto. For example, the router 100 may adjust the priorities of network sources, the priorities of the electronic devices 201˜20N and/or assign the bandwidth of the electronic devices 201˜20N according to the environment information sectors, but it is not limited thereto. In another embodiment, the router 100 is arranged to transmit data to the electronic devices 201˜20N according to the communication protocols, browser types, platform information and/or operating system types of the electronic devices 201˜20N. For example, when the browser of the first electronic device 201 is Chrome, the router 100 only transmits the data compatible to Chrome language to the first electronic device 201 to reduce the amount of data transmission. In the prior art, the router 100 would transmit data compatible to a plurality of browser languages to the electronic devices 201˜20N which results in the larger amount of transmission data, because the router 100 does not know the browser type of the electronic devices 201˜20N. In other embodiment, the controller 106 of the router 100 is also arranged to provide a setting suggestion according to the environment information sectors and enable the communication module 102 to transmit the setting suggestion to the corresponding electronic device, wherein the setting suggestion includes network setting of the router 100 and/or the corresponding electronic device electronic device, such that the user of the corresponding electronic device will be informed what kind of setting is appropriate and can set the network parameters according to the setting suggestion.

The network service module 108 is arranged to provide network service for the electronic devices 201˜20N, respectively, according to the environment information sectors of the setting table and/or a predetermined rule stored in the storage device 104. For example, the network service module 108 may determine the priority and bandwidth of the electronic devices 201˜20N according to the network speed, network interface(s), routing rule and/or computing capacity of the corresponding electronic devices 201˜20N, but it is not limited thereto. In one embodiment, the network service module 108 is a differentiated service provider (DSP), but it is not limited thereto.

The client information processing module 110 is arranged to receive the environment information sectors of the corresponding electronic devices 201˜20N from the communication module 102 and store the environment information sectors of the corresponding electronic devices 201˜20N in the setting table.

In another embodiment, the information-gathering code is further arranged to re-collect the environment information sectors of the electronic devices 201˜20N at a predetermined time interval and transmit the re-collected environment information sectors to the router 100. The controller 106 is further arranged to perform a statistical analysis on the collected environment information sectors. For example, the controller 106 may perform a statistical analysis according to a plurality of environment information sectors of an electronic device. More specifically, the controller 106 may perform the statistical analysis based on the computing capacity, network speed and/or through pool of the electronic device and provide the service for the electronic device according to the statistical analysis result, but it is not limited thereto. In another embodiment, the controller 106 is arranged to provide the statistical analysis result to the network service module 108, such that the network service module 108 may also provide service for the electronic device according to the statistical analysis result. In yet another embodiment, the information-gathering code is arranged to collect the environment information sector of the electronic device 201˜20N after the electronic device 201˜20N is idle for a predetermined period, but it is not limited thereto.

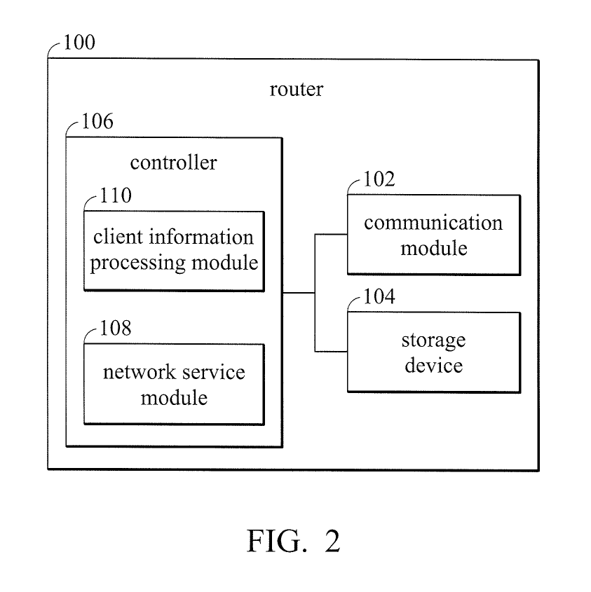

FIG. 2 is a schematic diagram illustrating another embodiment of an router of the present disclosure. The router 100 of FIG. 2 is similar to the router 100 of FIG. 1 except that the network service module 108 and the client information processing module 110 of the router 100 of FIG. 2 are implemented in the controller 106. In FIG. 1, the network service module 108 and the client information processing module 110 may be two integrated chips arranged to perform the above operations. In FIG. 2, the network service module 108 and the client information processing module 110 can be two program codes arranged to be loaded to the resistor of the controller 106 to be performed by the controller 106.

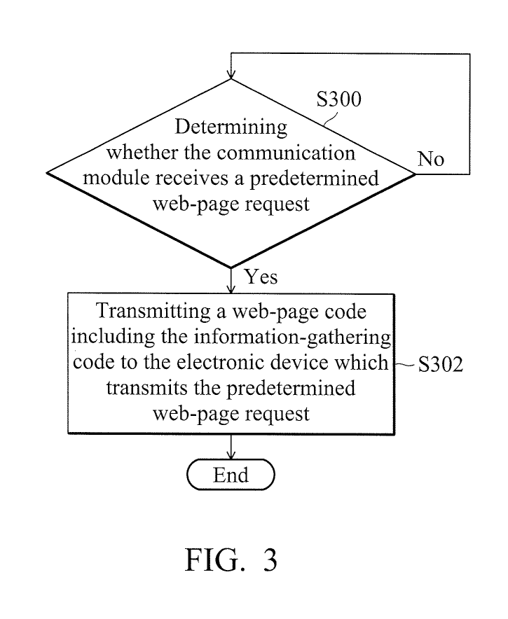

FIG. 3 is a flowchart of an information collection method according to an embodiment of the present disclosure. The information collection method is applied to the router 100 of FIG. 1 and FIG. 2. The process starts at step S300.

In step S300, the router 100 determines whether the communication module 102 receives a predetermined web-page request from one of the electronic devices 201˜20N. When the communication module 102 receives a predetermined web-page request from one of the electronic devices 201˜20N, the process goes to step S302, otherwise, the router 100 continues to determine whether the communication module 102 receives a predetermined web-page request from one of the electronic devices 201˜20N.

In step S302, the controller 106 enables the communication module 102 to transmit the web-page code, which includes the information-gathering code, to the electronic device which sends a predetermined web-page request to the communication module 102. For example, when the communication module 102 receives a predetermined web-page request from the first electronic device 201, the controller 106 enables the communication module 102 to transmit the information-gathering code, which includes the web-page code, to the first electronic device 201. It should be noted that the information-gathering code is arranged to collect the environment information of the electronic devices 201˜20N and transmit the collected environment information back to the router 100. In one embodiment, the web-page code is a Hyper Text Markup Language (HTML) and the information-gathering code is a script of the Hyper Text Markup Language (HTML), but it is not limited thereto. The web-page code may be program code compatible to other languages. The process ends at step S302.

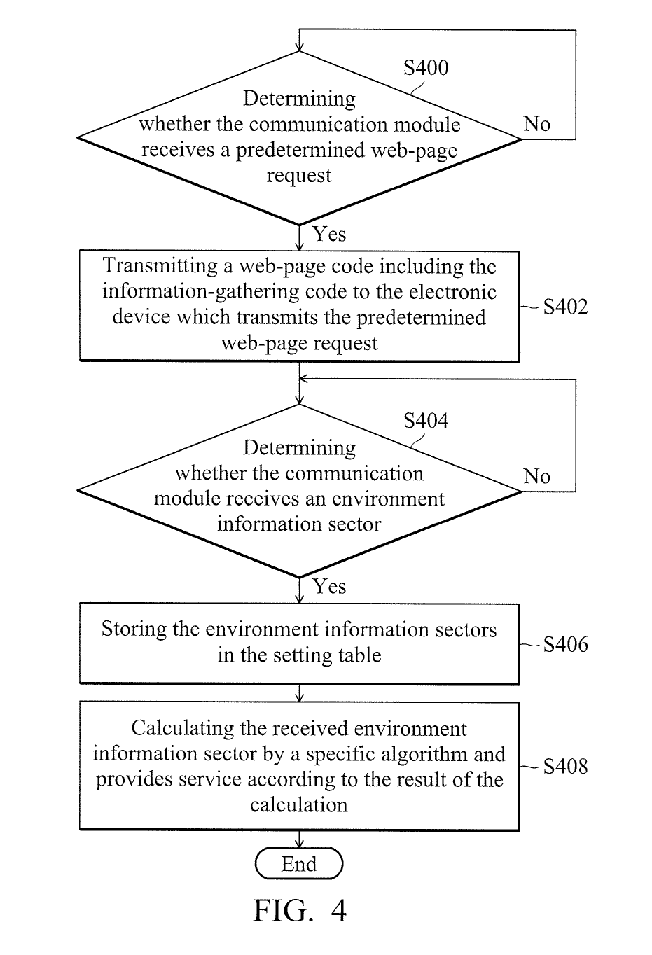

FIG. 4 is a flowchart of an information collection method according to another embodiment of the present disclosure. The information collection method is applied to the router 100 of FIG. 1 and FIG. 2. The process starts at step S400.

In step S400, the router 100 determines whether the communication module 102 receives a predetermined web-page request from one of the electronic devices 201˜20N. When the communication module 102 receives a predetermined web-page request from one of the electronic devices 201˜20N, the process goes to step S402, otherwise, the router 100 continues to determine whether the communication module 102 receives a predetermined web-page request from one of the electronic devices 201˜20N.

In step S402, the controller 106 enables the communication module 102 to transmit the web-page code, which includes the information-gathering code, to the electronic device which sends a predetermined web-page request to the communication module 102. For example, when the communication module 102 receives a predetermined web-page request from the first electronic device 201, the controller 106 enables the communication module 102 to transmit the information-gathering code, which includes the web-page code, to the first electronic device 201. It should be noted that the information-gathering code is arranged to collect the environment information of the electronic devices 201˜20N and transmit the collected environment information back to the router 100. In one embodiment, the web-page code is a Hyper Text Markup Language (HTML) and the information-gathering code is a script of the Hyper Text Markup Language (HTML), but it is not limited thereto. The web-page code may be program code compatible to other languages.

Next, in step S404, the router 100 determines whether the communication module 102 receives an environment information sector transmitted by one of the electronic device 201˜20N. when the communication module 102 receives the environment information sector from one of the electronic device the process goes to step S406, otherwise, the router 100 continues to determine whether the communication module 102 receives an environment information sector transmitted by one of the electronic device 201˜20N.

Next, in step S406, the client information processing module 110 is arranged to receive the environment information sector from the communication module 102 and store the environment information sector of the corresponding electronic device in the setting table, wherein each environment information sector may include the network speed (speed test), the specification of network interface card, the routing rule, the communication protocol, the browser type, the platform information, the operating system type and/or the computing capacity of the corresponding electronic device, but it is not limited thereto. In one embodiment, the environment information sector includes whether the corresponding electronic device support the IPv6 communication protocol.

Next, in step S408, the router 100 calculates the received environment information sector by a specific algorithm and provides service according to the result of the calculation. The specific algorithm can be designed by the router development companies, but it is not limited thereto. For example, the router 100 may adjust the priorities of network sources, the priorities of the electronic devices 201˜20N and/or assign the bandwidth of the electronic devices 201˜20N according to the environment information sectors, but it is not limited thereto. In another embodiment, the router 100 is arranged to transmit data to the electronic devices 201˜20N according to the communication protocols, browser types, platform information and/or operation system types of the electronic devices 201˜20N. For example, when the browser of the first electronic device 201 is Chrome, the router 100 only transmits the data compatible to the Chrome language to the first electronic device 201 to reduce the amount of data being transmitted. In the prior art, the router 100 transmits data compatible to a plurality of browser languages to the electronic devices 201˜20N which results in the larger amount of transmission data, because the router 100 does not has the browser type of the electronic devices 201˜20N. In other embodiment, the controller 106 of the router 100 is further arranged to provide a setting suggestion according to the environment information sector for the corresponding electronic device and enable the communication module 102 to transmit the setting suggestion to the corresponding electronic device, wherein the setting suggestion includes network setting of the router 100 and/or the corresponding electronic device, such that the user of the corresponding electronic device will be informed that what kind of the setting is appropriate and can set the network parameters according to the setting suggestion. In one embodiment, the network service module 108 of the router 100 is arranged to provide network service for the electronic devices 201˜20N, respectively, according to the environment information sectors of the setting table and/or a predetermined rule stored in the storage device 104. For example, the network service module 108 may determine the priority and bandwidth of the electronic devices 201˜20N according to the network speed, network interface(s), routing rule and/or computing capacity of the corresponding electronic devices 201˜20N, but it is not limited thereto. In one embodiment, the network service module 108 is a differentiated service provider (DSP), but it is not limited thereto. In another embodiment, the information-gathering code is further arranged to re-collect the environment information sectors of the electronic devices 201˜20N at a predetermined time interval and transmit the re-collected environment information sectors to the router 100. The controller 106 is further arranged to perform a statistical analysis on the collected environment information sectors, and update the setting table according to the statistical analysis result. The process ends at step S408.

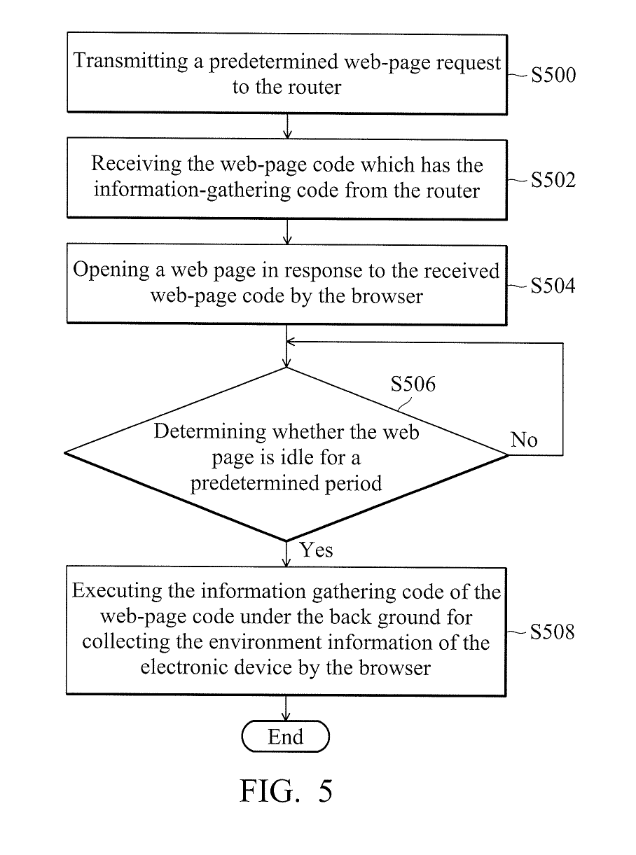

FIG. 5 is a flowchart of an information collection method according to another embodiment of the present disclosure. The information collection method is applied to any of the electronic devices of FIG. 1 and FIG. 2. The process starts at step S500.

In step S500, the electronic device transmits a predetermined web-page request to the router 100. For example, the predetermined web-page request may be an IP address, and the web page which is requested to be connected by the predetermined web-page request is a setting page which is required to be accessed when the electronic device is coupled to the router 100 for the first time, but it is not limited thereto.

Next, in step S502, the electronic device receives the web-page code which has the information-gathering code from the router 100.

Next, in step S504, the browser of the electronic device open a web page in response to the received web-page code.

Next, in step S506, the electronic device determines whether the web page is idle for a predetermined period. When the web page is idle for a predetermined period, the process goes to step S508, otherwise, the electronic device continues to determine whether the web page is idle for a predetermined period.

In step S508, the browser of the electronic device executes the information-gathering code of the web-page code in the background for collecting the environment information of the electronic device. In one embodiment, In the period in which the web page is opened, the information-gathering code collects the environment information sector of the electronic device and enable the electronic device to transmit the collected environment information sector back to the router 100, wherein the environment information sector may include the network speed (speed test), the specification of network interface card, the routing rule, the communication protocol, the browser type, the platform information, the operating system type and/or the computing capacity of the corresponding electronic device, but it is not limited thereto. In one embodiment, the environment information sector includes whether the corresponding electronic device support the IPv6 communication protocol. The process ends at step S508.

The router 100 and the information collection method provided by the present invention may provide the different services to the coupled electronic devices according to the information collected by web page.

Data transmission methods, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A router, comprising:
a storage device, arranged to store a web-page code corresponding to a graphical user interface, wherein the web-page code comprises an information-gathering code;
a communication module, coupled to a plurality of electronic devices; and
a controller, arranged to enable the communication module to transmit the web-page code to a first electronic device of the plurality of electronic devices in response to a predetermined web-page request received by the communication module from the first electronic device, wherein the information-gathering code is arranged to collect an environment information sector of the first electronic device and transmit the environment information sector of the first electronic device to the router.

2. The router as claimed in claim 1, wherein the controller is arranged to provide a setting suggestion according to the environment information sector and enable the communication module to transmit the setting suggestion to the first electronic device, wherein the setting suggestion comprises network settings of the router and/or the first electronic device.

3. The router as claimed in claim 1, further comprising a network service module arranged to provide network service to the electronic devices according to a setting table of the storage device, wherein the controller is further arranged to update the setting table according to the environment information sector.

4. The router as claimed in claim 3, further comprising a client information processing module arranged to receive the environment information sectors of the electronic devices and store the environment information sectors of the electronic devices in the setting table.

5. The router as claimed in claim 3, wherein the network service module is a differentiated service provider (DSP).

6. The router as claimed in claim 3, wherein the information-gathering code is further arranged to re-collect the environment information sector of the first electronic device at a predetermined time interval and transmit the re-collected environment information sector of the first electronic device to the router.

7. The router as claimed in claim 6, wherein the controller is further arranged to perform a statistical analysis on computing capacity, network speed or through pool of the electronic devices according to the collected environment information sectors.

8. The router as claimed in claim 1, wherein the environment information sector comprises the network speed, the specification of network interface card, the routing rule, the communication protocol, the browser type, the platform information, the operating system type and/or the computing capacity of the first electronic device.

9. The router as claimed in claim 1, wherein the information-gathering code is performed by a browser of the first electronic device.

10. The router as claimed in claim 9, wherein the web-page code is a Hyper Text Markup Language (HTML), and the information-gathering code is a script of the Hyper Text Markup Language.

11. An information collection method, applied to a plurality of electronic devices coupled with a router, the information collection method comprising:
determining whether a predetermined web-page request is received from the coupled electronic devices; and
transmitting a web-page code to a first electronic device of the electronic devices when the predetermined web-page request is received from the first electronic device, wherein the web-page code comprises an information-gathering code, and the information-gathering code is arranged to collect an environment information sector of the first electronic device.

12. The information collection method as claimed in claim 11, further comprising:
determining the environment information sector of the first electronic device transmitted by the information-gathering code is received from the first electronic device;
producing a setting suggestion according to the environment information sector when the environment information sector of the first electronic device is received; and
transmitting the setting suggestion to the first electronic device, wherein the setting suggestion comprises network setting of the router and/or the first electronic device.

13. The information collection method as claimed in claim 11, further comprising:
determining whether the environment information sector of the first electronic device transmitted by the information-gathering code is received from the first electronic device;
updating a setting table according to the environment information sector; and
providing network service to the electronic devices by a network service module, respectively, according to the setting table.

14. The information collection method as claimed in claim 13, further comprising storing the environment information sector of each of the electronic devices in the setting table.

15. The information collection method as claimed in claim 13, wherein the network service module is a differentiated service provider (DSP).

16. The information collection method as claimed in claim 13, wherein the information-gathering code is further arranged to re-collect the environment information sector of the first electronic device at a predetermined time interval and transmit the re-collected environment information sector of the first electronic device to the router.

17. The information collection method as claimed in claim 16, further comprising:
receiving the environment information sectors re-collected by the information-gathering code from the first electronic device; and
performing a statistical analysis on computing capacity, network speed or through pool of the electronic devices according to the collected environment information sectors.

18. The information collection method as claimed in claim 11, wherein the environment information sector comprises the network speed, the specification of network interface card, the routing rule, the communication protocol, the browser type, the platform information, the operating system type and/or the computing capacity of the first electronic device.

19. The information collection method as claimed in claim 11, wherein the information-gathering code is performed by a browser of the first electronic device.

20. The information collection method as claimed in claim 19, wherein the web-page code is a Hyper Text Markup Language (HTML), and the information-gathering code is a script of the Hyper Text Markup Language.
